(19) United States
(12) Patent Application Publication
(10) Pub. No.: US 2009/0271750 A1
(43) Pub. Date: Oct. 29, 2009

(54) TIMING CONSTRAINT MERGING IN HIERARCHICAL SOC DESIGNS

(75) Inventors: Judith Richardson, Saratoga, CA (US); Niranjan A. Puttaswamy, Santa Clara, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/095,164

(22) PCT Filed: Nov. 30, 2006
(86) PCT No.: PCT/IB2006/054520

§ 371 Date: Jan. 23, 2009

(30) Foreign Application Priority Data
Nov. 30, 2006 (IB) PCT/IB2006/054520

(51) Int. Cl. G06F 17/50

(52) U.S. Cl. 716/6

(57) ABSTRACT

A method for propagating timing constraints from lower level design blocks to higher level design blocks includes o the steps of designing a circuit containing a plurality of design blocks. Each of the plurality of design blocks has a set of timing constraints associated therewith. A composite set of timing constraints is created for the circuit from each of the set of timing constraints associated with each of the plurality of design blocks, according to an established propagation rule set.

Many designs, especially platform-based logic designs, have a large percentage of reusable Intellectual Property (IP) Blocks. These IP Blocks form predesigned functional blocks that can be used in a larger design. When these IP Blocks are provided to the design integrator they have several different types of information. One of these different types of information is a set of timing constraints.

Electronic Design Automation (EDA) tools require timing constraints for the entities on which they are operating. This may be for the whole design, or it may be an intermediate level hierarchical block (a chiplet) incorporated within the design. These entities do not usually correspond to a single IP Block. Examples of EDA tools that need timing constraints are physical synthesis, placement and routing, and timing analysis. These all operate either at chiplet or full chip level, so that is the level for which they need constraints. Often constraints do not exist for the entire design, but they do exist for the separate IP Blocks within the design. An efficient way is needed to merge these separate constraints to make ones for higher levels.

Existing tools can manipulate constraints for an entire design, for example by timing budgeting, to create constraints for the chiplets, or lower levels of the design hierarchy. But existing tools cannot derive a set of timing constraints for a higher level of a design from lower level timing constraints. Currently this must be done manually. This is not a simple concatenation process, since only some of the timing constraints need to be propagated to a higher level. It is a time consuming, error prone process, often requiring several man weeks to complete and verify. The process is repeated, with somewhat different inputs, whenever the design changes.

The present invention disclosed and claimed herein, in one aspect thereof comprises a method for propagation of timing constraints from lower level design blocks to higher level design blocks. A circuit containing a plurality of design blocks is designed such that each of the plurality of design blocks has a set of timing constraints associated therewith. A composite set of timing constraints are created for the circuit from each of the set of timing constraints associated with each of the plurality of design blocks according to an established propagation rule set.

A more complete understanding of the method and apparatus of the present invention may be obtained by reference to the following Detailed Description when taken in conjunction with the accompanying Drawings wherein:

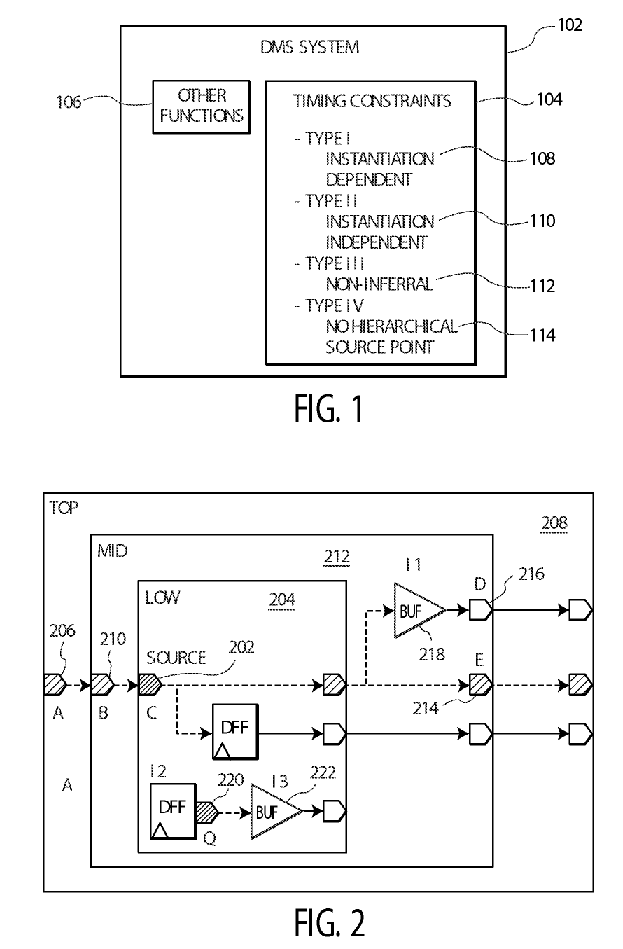

FIG. 1 is a block diagram of a Design Manipulation System;

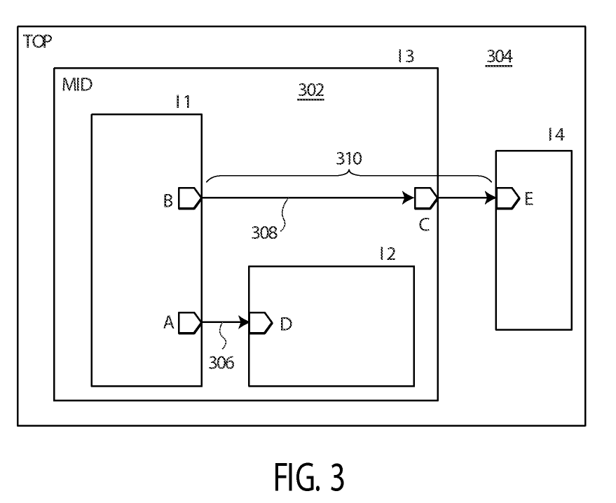

FIG. 2 illustrates the implementation of a Type I Timing Constraint;

FIG. 3 illustrates the implementation of a Type II Timing Constraint;

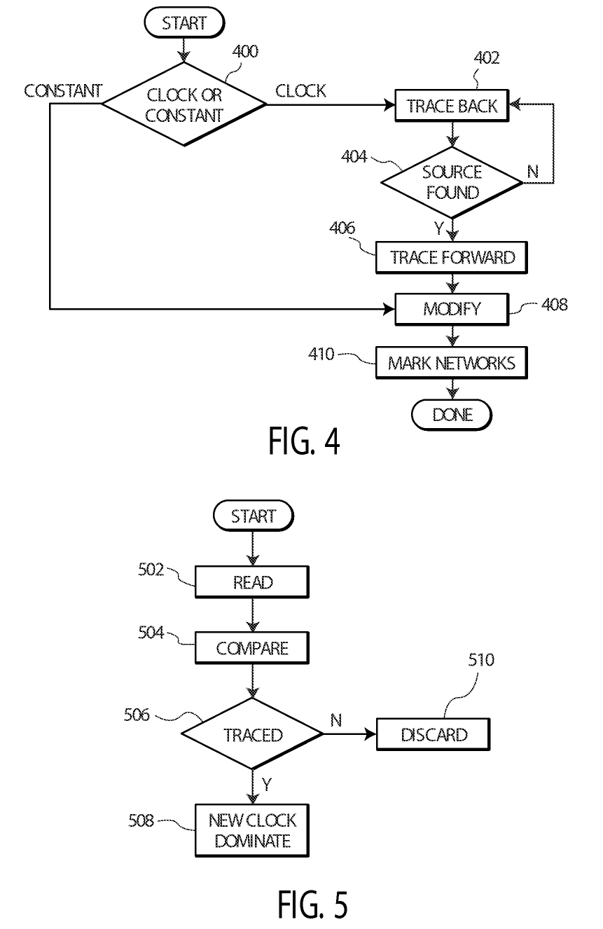

FIG. 4 is a flow diagram illustrating the propagation of a Type III Timing Constraint; and

FIG. 5 is a flow diagram illustrating resolution of conflicts of Type III Timing Constraints.

Referring now to the drawings, and more particularly to FIG. 1, there is illustrated the present system implemented within a Design Manipulation System. The present disclosure has been implemented in a computer program called a Design Manipulation System (DMS) 102. The DMS system 102 enables the design of a system using various combinations of existing IP Blocks. The generated design will operate according to various established timing constraints 104, the DMS System 102 also makes use of other design functions 106.

The timing constraints are described herein in terms of their implementation in SDC (Synopsis Design Constraint) format. There are four categories of timing constraints. Type I Timing Constraints 108 are dependent on the instantiation of the block for which they are defined. Type I Timing Constraints include, but are not limited to, constraints such as set_input_delay, set_load or set_driving_cell. They are usually, though not always, defined in terms of ports of the IP Block. If the IP Block is instantiated in a hierarchy, these timing constraints should be inferred from the context, except when they map directly to the boundary of higher level.

Type II Timing Constraints 110 are independent of the instantiation context. These Constraints include, but are not limited to, set_case_analysis, set_false_path, and set_multicycle_path. These timing constraints may be defined in terms of ports of the IP Block, instance pins of lower level IP Blocks or leaf cells, nets or clocks. These timing constraints can not be inferred from the context, and must be propagated to the higher level of the design.

Type III Timing Constraints 112 cannot be inferred but may conflict with constraints from the context, such as create_clock or create_generated_clock. Typically an IP Block has a clock constraint defined from an input pin with a period that corresponds to the maximum frequency at which the IP Block is intended to run. In a system, this input pin may be connected to a clock that is defined with a different frequency. Finally, Type IV Timing Constraints do not have a hierarchical source point. Examples of these constraints include, but are not limited to, set_wire_load_model or set_operating_conditions.

The first three types of Timing Constraints have a specific source point (or points) specified in terms of a block port, instance pin, or net. The fourth type of Constraint does not have a specific source point. To determine whether a timing constraint applies to the boundary of a target level, a “connected cloud” is defined. A connected cloud includes the nets, pins and ports that connect directly to the source point of a timing constraint. A connected cloud is bounded by leaf cell (library or black box) instance pins or top level ports. The connected cloud is not bounded by intermediate hierarchy levels.

Referring now to FIG. 2, there illustrated the implementation of a Type I timing constraint. Port C 202 of Block Low 204 is the source of the Type I timing constraint. The connected cloud includes port A 206 of the Top level 208, port B 210 of Mid level 212, and port E 214 of Mid level 212. The connected cloud does not include port D 216 of Mid level 212 because the connected cloud stops at the input to the buffer 218. The procedure for handling Type I timing constraints defined for Block Low 204 and creating timing constraints for Block Mid 212 based upon these lower level timing constraints may be described as follows. If any part of the connected cloud is present at the boundary of the target level, the timing constraint is propagated. If the connected cloud does not reach the boundary, the timing constraint is discarded and not passed to the upper level. For example, if the Mid level 212 is the target level and a set_input delay constraint (Type I) is defined for port C 202 of Block Low 204, the set input delay constraint is propagated to the next level for port B 210 of Block Mid 212. If a set_output_delay constraint (Type I) is defined for pin Q of instance I2 220, this constraint is discarded because the connected cloud stops at buffer 222 and does not reach the boundary.

Referring now to FIG. 3, there is illustrated the implementation of a Type II timing constraint. Type II timing constraints are all propagated. Hierarchy level(s) are added (or removed) as required. A Type II timing constraint defined on a port of lower level Block may become a constraint on an instance pin for the target level. False paths and multi-cycle paths must be traced through the netlist to identify where they enter or leave the target level. This tracing does not stop at combinatorial logic. The tracing continues until it reaches either a clocked element, a port of the top level, or another part of the same false path. Examples of the process for propagating Type II constraints are more fully illustrated in FIG. 3. For example, if the constraints were defined for the Mid level 302, and Top level 304 is the target level, a false path 306 defined from instance pin I1/A to I2/D, inside Mid level 302, will become a false path from I3/I1/A to pin I3/I2/D at the higher level. A false path 308 defined from instance pin I1/B to port C of Mid level 302, becomes a false path from I3/I1/B to pin I3/C. If the Type II constraints are defined for the Top level 304, and the Mid level 302 is the target level, a false path 306 defined from instance pin I3/I1/A to pin I3/I2/D becomes a false path from instance pin I1/A to I2/D. A false path defined from instance pin I3/I1/B to pin I4/E becomes a false path 308 from instance pin I1/B to port C.

Referring now to FIG. 4, there is illustrated a flow diagram illustrating the propagation of a Type III constraint. When a Type III clock constraint is determined at inquiry step 400, the network is traced back at step 402 from the original source through any buffers or inverters (i.e. non-branching combinatorial logic) until a driving source point is found at inquiry step 404. This could be a top-level port, a clocked leaf instance or a combinatorial instance. The network is traced forward at step 406 from this new source point, through any combinatorial logic, to all the clocked instances it controls. This forward tracing is modified at step 408 by the presence of any constant values that are applied to the combinatorial logic. For example, if the combinatorial element is a multiplexer and there are constant values on the select lines, the selection is obeyed. These constant values could be either from the netlist (e.g. a constant zero from 1'b0 in Verilog), or from other constraints (e.g. set_case_analysis). As the network is traced, each visited net is marked as being a clock or a constant value at the step 410. When inquiry step 400 determines a constant constraint is defined, this constraint is not traced back to a source. The constraint is only traced forward through the combinatorial logic at step 406.

When the constraints from more than one IP Block are being propagated, there may be conflicts. For example, each IP Block may have its own clock definition, but these are all driven by the same source. The defined source of each clock is significant in resolving such conflicts as illustrated in FIG. 5. When a clock definition is read at step 502, its defined source is compared with previously traced clocks at step 504. If the defined source corresponds to a traced source at step 506, this newly read clock is taken as the dominant one at step 508, replacing other clocks that traced back to this source. An example of this would be when there is a clock generation block, and the clock defined as coming from this is taken as overriding any clocks defined in other IP Blocks that are driven by this clock. If the defined source is not a previously traced source, but a previous clock has been traced through this source, this clock is discarded at step 510. So the sequence in which the constraints are read is significant. This would be the case where two or more IP Blocks each have their own definitions of what is in fact the same clock.

Type IV Timing Constraints do not need to be modified to apply to a higher level. If there are multiple different values for the same constraint type, such as different operating conditions, the most restrictive constraint is propagated. Virtual clocks, i.e. clocks that have been defined with no specific source, are always propagated.

Some design tools require ports to have certain constraints specified, such as non-clock inputs, relative to a clock. If the port does not have such a constraint, found by propagating from the defined constraints, one is generated. This is done by tracing (backward from outputs, forward from inputs) to clocked elements. The highest frequency clock of these elements is used, and a delay constraint is created as a percentage of this period.

The clocks for a design may be generated externally and brought on chip through pads, or they may be generated internally, e.g. with PLLs. Any timing constraints provided for either of these clock generation sources must override clock constraints traced from other IP Blocks. This is because the constraints supplied with an IP Block may be for a scenario that does not apply to the current design instantiation. For example a memory controller may be capable of running at 250 MHz, but the design only requires 225 MHz. This situation is covered in the procedure for Type III timing constraints, which takes account of the defined source of the clock when resolving conflicts.

This method can be used in any hierarchical design where timing constraints are provided for individual IP Blocks, and constraints are needed for top level or chiplet level. Such designs include platform-based designs such as Nexperia Home or Nexperia Mobile designs.

Many variations and embodiments of the above-described invention and method are possible. Although only certain embodiments of the invention and method have been illustrated in the accompanying drawings and described in the foregoing Detailed Description, it will be understood that the invention is not limited to the embodiments disclosed, but is capable of additional rearrangements, modifications and substitutions without departing from the invention as set forth and defined by the following claims. Accordingly, it should be understood that the scope of the present invention encompasses all such arrangements and is solely limited by the claims as follows.

1. A method for propagating timing constraints from lower level design blocks to higher level design blocks, comprising the steps of:
designing a circuit containing a plurality of design blocks, each of the plurality of design blocks having a set of timing constraints associated therewith; and
creating a composite set of timing constraints for the circuit from each of the set of timing constraints associated with each of the plurality of design blocks according to an established propagation rule set.

2. The method of claim 1, wherein the step of creating further includes the step of resolving conflicts between sets of timing constraints associated with each of the plurality of design blocks.

3. The method of claim 1, wherein the step of creating further comprises the steps of:
determining, for timing constraints that are dependent on instantiation of blocks associated with the timing constraints, a connected cloud for a source point of a timing constraint;
determining if the connected cloud reaches a boundary of at least one design blocks of the circuit;
propagating the timing constraint to a next design block if the connected cloud reaches the boundary of the at least one of the design blocks to of the circuit; and
discarding the timing constraint if the connected cloud does not reach the boundary of the at least one design blocks of the circuit.

4. The method of claim 1, wherein the step of creating further comprises the step of propagating, for timing constraints independent of an instantiation context, a timing constraint along a path until reaching at least one of a clocked element, a port of a top design level or another part of the path.

5. The method of claim 1, wherein the step of creating further comprises the steps of:
determining, for timing constraints that cannot be inferred, if a timing constraint is a clock constraint or a constant constraint;
if the timing constraint is a clock constraint;
tracing back the timing constraint from an original source to a driving source; propagating the timing constraint forward to all clocked instances the timing constraint controls from the driving source;
if the timing constraint is a constant constraint; and
propagating the timing constraint forward to all clocked instances the timing constraint controls from the original source.

6. The method of claim 1, wherein the step of creating further comprises the steps of:
determining, for timing constraints that do not have a hierarchical source point, if there are multiple different values for a timing constraint; and
propagating a most restrictive value if there are multiple different values for the timing constraint.

7. The method of claim 1, wherein the step of creating further comprises the step of creating a delay constraint from a defined timing constraint.

8. The method of claim 1, wherein the step of creating further comprises the step of overriding clock constraints traced from other design blocks with clock constraints generated internally or externally.

9. An apparatus for propagating timing constraints from lower level design blocks to higher level design blocks, comprising the steps of:
a computer readable media containing machine readable code, said machine readable code configuring a general purpose computer to:
design a circuit containing a plurality of design blocks, each of the plurality of design blocks having a set of timing constraints associated therewith; and
create a composite set of timing constraints for the circuit from each of the set of timing constraints associated with each of the plurality of design blocks according to an established propagation rule set.

10. The apparatus of claim 9, wherein the machine readable code further configures the general purpose computer to resolve conflicts between sets of timing constraints associated with each of the plurality of design blocks.

11. The apparatus of claim 9, wherein the machine readable code further configures the general purpose computer to:
determine, for timing constraints that are dependent on instantiation of blocks associated with the timing constraints, a connected cloud for a source point of a timing constraint;
determine if the connected cloud reaches a boundary of at least one of the designs blocks of the circuit;
propagate the timing constraint to a next design block if the connected cloud reaches the boundary of the at least one design blocks of the circuit; and
discard the timing constraint if the connected cloud does not reach the boundary of the at least one design blocks of the circuit.

12. The apparatus of claim 9, wherein the machine readable code further configures the general purpose computer to propagate, for timing constraints independent of an instantiation context, a timing constraint along a path until reaching at least one of a clocked element, a port of a top design level or another part of the path.

13. The apparatus of claim 9, wherein the machine readable code further configures the general purpose computer to:
determine, for timing constraints that cannot be inferred, if a timing constraint is a clock constraint or a constant constraint;
if the timing constraint is a clock constraint;
trace back the timing constraint from an original source to a driving source;
propagate the timing constraint forward to all clocked instances the timing constraint controls from the driving source;
if the timing constraint is a constant constraint; and
propagate the timing constraint forward to all clocked instances the timing constraint controls from the original source.

14. The apparatus of claim 9, wherein the machine readable code further configures the general purpose computer to:
determine, for constraints that do not have a hierarchical source point, if there are multiple different values for a timing constraint; and
propagate a most restrictive value if there are multiple different values for the timing constraint.

15. The apparatus of claim 9, wherein the machine readable code further configures the general purpose computer to create a delay constraint from a defined timing constraint.

16. The apparatus of claim 9, wherein the machine readable code further configures the general purpose computer to override clock constraints traced from other design blocks with clock constraints generated internally or externally.
